(19) United States
(12) Patent Application Publication
(10) Pub. No.: US 2016/0052792 A1
(43) Pub. Date: Feb. 25, 2016

(54) METHOD FOR PRODUCING A FIELD GRADING MATERIAL WITH TAILORED PROPERTIES

(71) Applicant: HYDOR-QUEBEC, Varennes (CA)

(72) Inventor: Sylvio Savoie, Ste-Julie (CA)

(21) Appl. No.: 14/780,966

(22) PCT Filed: Mar. 28, 2013
(86) PCT No.: PCT/CA2013/050252

§ 371 Date: Sep. 28, 2015

(51) Int. Cl. C01B 35/04; H01B 1/16; H02G 15/064

(52) U.S. Cl. CPC C01B 35/04; H02G 15/064; H01B 1/16

(57) ABSTRACT

The present disclosure relates to a novel method for producing a field grading powder, to novel field grading powder and their uses and method of uses. The method for producing the field grading powder with semi-conductor properties comprises the steps of i) ball milling under high energy a metal powder and a boron compound for creating an homogenous powder, ii) firing the homogenous powder at a temperature and a time sufficient to create a metal boride powder, and iii) cooling down the metal boride powder from step b) for obtaining a field grading powder having semi-conductor properties.

### FIELD OF THE DISCLOSURE

The present disclosure relates to a method for producing a field grading material, as well as the new field grading material so produced and its uses.

### BACKGROUND OF THE DISCLOSURE

The globally increasing demand of energy is a technical challenge for the electrical generation, transmission and distribution systems. This requires often contradictory features such as increasing voltage levels in combination with more compact designs. This leads to an increased electric stress on the insulation systems. This can be addressed by using insulating materials with tunable non-linear conductivity, as well as high dielectric constant and low loss, for electric field grading applications.

Traditionally non-linear field grading materials have been used in cable terminations and end windings intended for use under alternating current conditions at medium voltage. For many years now, composite non-linear field grading materials have been used to avoid stress concentrations in high voltage applications such as cable accessories and end windings of rotating machines.

The presence of corona discharges is a recognized problem encountered in high-voltage (HV) applications. Hence the interest in applying field grading materials to other components, under direct current conditions and at high voltage has increased. Operation under such diverse conditions puts considerable demands on the performance of the composite materials as well as their constituents.

Current field grading materials consist of polymer, semi-conducting ceramic particles such as SiC, ZnO etc., as well as lower amounts carbon black, embedded in a polymer matrix. The composite materials consist of an insulating matrix filled with conducting or semi-conducting particles. Silicon carbide (SiC) powder is one such filler that is being employed in cable terminations, paint and tapes. ZnO powder was early used in surge arresters due to its voltage dependent, varistor-type characteristic. However, the stress grading performance sometimes lacks in robustness and reproducibility as well.

For situations as described above and others, silicon carbide (SiC) powder added to tape or paint is now being used as a field grading material in the insulation systems of modern high voltage power generators. However, this field smoothing material presents certain limitations for such applications, as well as for emerging applications involving frequent overvoltages faced by motors. One recognized hindrance is the fact that the conductivity values of SiC powder can vary widely for different source samples, as a function of particle size, impurities, preparation, etc. Such lack of consistency and reproducibility conceivably limits its use as a field grading material. To circumvent this, manufacturers proceed by mixing different grades of SiC powder in order to adjust the resistivity of the material and improve the electric field distribution for a desired application. Even then, certain difficulties still remain to be overcome, such as the design of voltage response as a function of frequency. All these difficulties indicate that SiC is limited in its use for future applications, such as in power cables, switching devices, inverters, etc.

In light of these new emerging applications, it has now become apparent that it would be desirable to be provided with new field grading materials with robust and reproducible performance, with electric properties that can be tailored to its intended use.

To obtain such new field grading materials with robust and reproducible performance, it has also become apparent that a new method for producing such field grading material may be desirable.

### SUMMARY OF INVENTION

In one aspect of the invention, there is provided a new method for producing a field grading material with tailored properties.

In a further aspect of the invention, there is also provided new field grading material prepared by this new method, and their uses.

Still in a further aspect of the invention, there is provided a method for producing a field grading powder with semi-conductor properties, said method comprising the steps of:
a) ball milling under high energy a metal powder and a boron compound to obtain an homogenous powder;
b) annealing said homogenous powder at a temperature and a time sufficient for creating a metal boride powder; and
c) cooling down the metal boride powder from step b) for obtaining a field grading powder having semi-conductor properties.

In preferred embodiments, the metal boride is AlₓB_{y}, FeB, or ZrB₂, where x and y may vary resulting in different aluminum borides depending on the time of milling and firing.

In a specific embodiment, the metal is aluminum, iron or zirconium, and more preferably aluminum.

The boron compound in alternate embodiments may be boron nitride, boric acid, borate or boron oxide.

In alternate embodiments, the temperature of annealing may be of at least 900° C., and preferably of at least 1040° C.

In alternate embodiments, the time of annealing may be of at least 1 hour, and preferably of at least 2 hours.

In accordance with a further aspect of the invention, there is provided a field grading powder as produced by the method as described herein.

In alternates embodiments, the field grading powder comprises AlₓB_{y}, FeB, or ZrB₂, where x and y may vary resulting in different aluminum borides.

Still in a further aspect of the invention, there is provided the use of a field grading powder as defined herein, for field grading. Such use may be for example in cable terminations and end windings.

The present invention also provides for a method for producing a field grading material, incorporating within such material or at its surface a field grading powder as defined herein.

The expression “field grading properties” as referred herein is intended to refer to properties adopted by field grading material to prevent failures (flashovers, punctures, thermal runaway) or degradation (partial discharges, tree formation) by controlling the electric field strength at critical locations. More particularly, the four main parameters defining field grading behavior are the relative permittivity εᵣ, the small-field conductivity σ (0), the switching field E_{b} and the non-linearity α.

The expression “custom-made” as referred herein is intended to mean that the custom-made field grading material (CFGP) can be made with different properties, and still be adapted for field grading. For example, a cable termination for a 600 V cable may require different properties than those for a cable termination for a cable carrying 20000 V. With the teaching found herein, a person skilled in the art will be able to adapt the general principle of the method to arrive at the desired properties.

The expression “for a time sufficient to create a metal boride powder” as referred herein is intended to mean the time necessary for generating a metal boride. In some instance, milling time may be affected by the crucible/balls used, the type of miller, the firing temperature and atmosphere under which the compounds are milled. In fact, one could increase the time of milling and reduce the firing temperature while still achieving in both cases the formation of a metal boride. Conversely, one could reduce the milling time and increase the firing temperature and still obtain a metal boride with field grading properties. The milling does not produce the metal boride. At the end of the milling step, the structure is too disorganized. No metal boride could be detectable by X-ray diffraction (XRD) at the end of the milling step only. It is understood that both the milling step and the firing step transfer energy to the compounds produced and this energy in total is responsible for the formation of the metal boride. For example, it will be demonstrated here that Al_{1.67}B₂₂ could be formed at a firing temperature of 900° C. even if the phase transition graph otherwise suggest a minimal temperature of 1027° C. The energy transferred during milling allowed to lower the temperature to 900° C. and still obtain the desired aluminum boride. The reader will be able without inventive skills to adapt those time of milling and firing temperature, with the guidelines provided herein to obtain a CFGP with good field grading properties. In fact, the metal boride can easily be detected after the firing step with routine XRD. The absence of any metal boride after firing is only indicative that the total energy was not sufficient and consequently either or both of the milling time and the firing temperature should be increased.

With the teaching of the present invention, one would now know the step to undertake to produce a metal boride with field grading properties. Moreover, the chemist will be able to easily test as it has be done here the content of the resulting milling reaction, without any difficulty, and undue experimentation.

### BRIEF DESCRIPTION OF THE FIGURES

FIG. 1 illustrates a phase transition graph of the aluminum boride formation.

FIG. 2 is an I-V conductivity curve illustrating the current vs. electric field response of various CFGPs prepared at 1040° C. for different ratios of aluminum/boron nitride.

FIG. 3 is an I-V conductivity curve illustrating the current vs. electric field response of various CFGPs prepared at 1040° C. with different milling times.

FIGS. 4A-4F are electron scanning micrographs illustrating at low and high magnitude the effect of milling time versus the microstructure after high energy milling for 6 hours (FIGS. 4A and 4D), 12 hours (FIGS. 4B and 4E), and 18 hours (FIGS. 4C and 4F) aluminum and boron nitride together.

FIG. 5 is an I-V conductivity curve illustrating the current vs. electric field response of the B2 CFGP mix milled for 12 hours and fired at various temperatures.

FIG. 6 is an I-V conductivity curve illustrating the current vs. electric field response of the compounded effects of milling time and firing temperature on the I-V slopes for the B2 CFGP mix.

FIG. 7 is an I-V conductivity curve illustrating the current vs. electric field response of a commercial SiC powder compared to the B3 CFGP mix.

FIGS. 8A and 8B illustrate XRD spectra of a CFGP annealed at 1040° C. for various milling times (8A) and milled for 12 hours at several annealing temperatures (8B).

FIG. 9 is an I-V conductivity curve illustrating the current vs. electric field response of a CFGP made of aluminum powder and boric acid, milled for 12 hours and fired at 900° C.

FIG. 10 is an I-V conductivity curve illustrating the current vs. electric field response of CFGPs made of aluminum and boron oxide, milled for 6 or 12 hours and fired at 900° C.

FIG. 11 is an I-V conductivity curve illustrating the current vs. electric field response of CFGPs containing FeB or ZrB₂.

### DESCRIPTION OF THE EMBODIMENTS

In the present application, we are demonstrating an innovative approach leading to a custom-made semi-conductive powder. This powder can certainly represent an alternative to SiC currently available in emerging future technologies involving high voltage (HV) electrical networks.

The innovative semi-conductive powder made with the process described herein was designed to fulfill all the required conditions for a good field grading filler material. The material was elaborated using various mixture reactions of available technical powders. The custom-made powder exhibited a non-linear electrical behaviour with adjustable non-linear parameters. Because these parameters can be adjusted, this powder can be custom-made for each specific application to get the best field grading properties for the intended use. This powder can manifest a similar behaviour to that of SiC. Furthermore, the nature and proportion of mixture powders can be varied, allowing the control of parameters, such as:
I-V slope variation;
thermal conductivity;
adjustable conductivity value;
easy and inexpensive elaboration; and
good process reproducibility.

Aluminum boride is known to be a conductor. However, when aluminum or any other metal is treated with the boron compound as described herein, the resulting powder adopts new semi-conductive properties, making it suitable for use as field grading powder, in field grading material.

The CFGP was obtained through a process involving the milling and annealing by firing of powder mixture. The CFGP discussed here was initially prepared using aluminum (Al) and boron nitride (BN) powders interacting upon high-energy milling and firing to produce a semi-conductive powder comprising aluminum nitride (AlN) and aluminum boride (AlₓB_{y}). It was also found that using alternate boron compounds and other metals with the same process would also allow the production of CFGP with field grading properties. For some other metals that are known to be difficult to ball mill, it may be necessary to use anti-sticking agents or other additives as customarily known in the art for ball milling such specific metals.

The new method for producing a powder tailored to fulfill the required conditions for field grading of HV applications uses high-energy ball milling and annealing (firing) processes. Excellent results in line with field grading requirements were found, and show that this powder can be custom-made for the intended applications. Conductivity characteristics similar to and/or at variance (when desired) with those of SiC were observed.

In the first step of the process, a metal powder is milled under high energy with a boron compound. High-energy ball milling is recognized for its use in mechanical alloying. This technique was selected in part because the milling improves the powder homogeneity. Moreover, many parameters can be controlled in this first fabrication step, including the stochoimetric ratio of metal to boron compound, the milling time, the firing temperature used for annealing, etc. It was found throughout the examples reported herein that increasing the milling time changes the boride production and the non-linearity of the conductivity curves obtained. As for the ratios of the metal source to the boron compound used, the ratio will affect the conductivity. The more metal is used compared to the boron compound, the more borides will be formed and the more conductivity is increased. Varying the firing temperature also affect the conductivity. Increasing the temperature produces less borides hence reduces the conductivity.

However, CFGPs cannot be produced using high-energy milling alone. The milling process only allows the insertion of boron in the metal structure. Thus, the reaction between the two powders remains incomplete. Without a firing step, the powder is highly conductive. It was found that the metal boride could not be produced using high energy ball milling alone. For example, after the milling process only, using aluminum and boron nitride, the incomplete decomposition of BN (into B and N atoms) and the formation of other phases can be described by the following reaction:

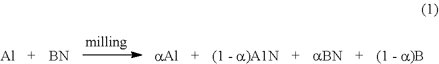

where α is a stoichiometric ratio. However, there are no aluminum borides generated.

In the second step of the process still with the compounds used as example above, annealing by firing is required to complete the reaction produced by ball milling. This step allows the realization of the reaction while controlling the applied temperature, the application time and the choice of atmosphere (vacuum or inert gas). With this step included in the process, the following reaction occurs:

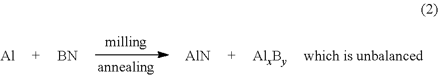

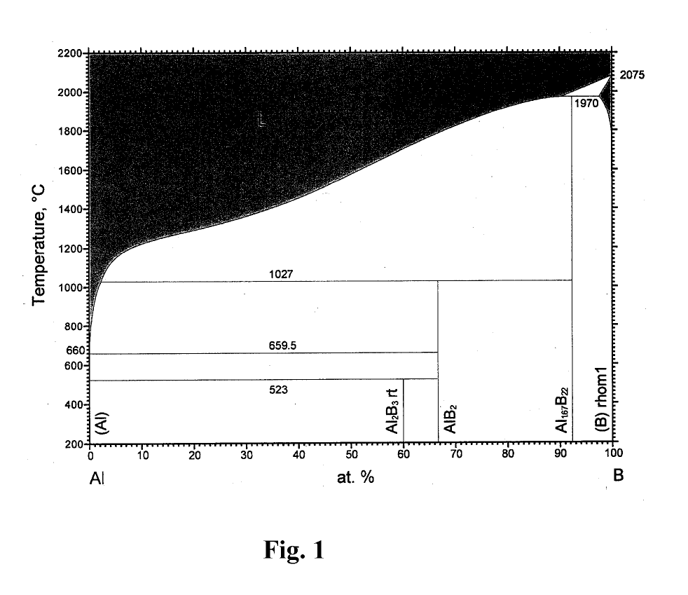

Depending on the firing temperature, various borides will be produced. Using the phase transition graph reproduced as FIG. 1, one may expect that firing at a temperature above 1027° C. would produce mostly Al_{1.67}B₂₂, but at lower temperature such as between 659.5 and 1027° C., AlB₂ will be the most predominant form of borides formed. In practice, as will be illustrated in the examples below, the firing temperature is preferably above 850° C. and more preferably above 900° C. for the milling time tested. However, if milled for a longer time, these temperature can be lowered. It is however expected that the firing temperature needs to be at least of 500° C., even for longer milling time.

Moreover, one would expect that slowing down the cooling down after firing would favor the equilibrium toward the naturally more predominant and stable compounds from the reaction. This may as well be the case. However, every reaction to produce CFGPs were left to cool down to room temperature under vacuum, i.e. the cooling down step was not controlled, and every CFGPs so produced had the desired properties for field grading. A cooling down step under normal pressure and an inert atmosphere would also be acceptable, as the cooling down step is not critical if otherwise not slowed down. In fact, it was calculated that without external acceleration or reduction of the cooling down, the mix was cooling down at a rate of about 10° C. per minutes until the mixes reach a temperature around 400° C., after which the cooling down was still left unattended, but slower as one may expect. Accordingly, it was found that inasmuch as the cooling down step is either unattended to, speeded up or quenched, the various borides are formed with the end results that the produced CFGPs have the desired field grading properties.

The effect of stochiometric ratios of metal to boron compound, the milling time and the annealing temperature will be illustrated in the following examples. As will also be illustrated, other additives may be added without affecting the CFGPs properties as field grading material. The CFGPs of the present invention can be prepared according to the procedures denoted in the following examples or modifications thereof using readily available starting materials, reagents, and conventional procedures or variations thereof well-known to a practitioner of ordinary skill in the art of mechanical alloying. These examples are given for illustrative purposes only and are not intended to limit the procedures described.

In the following examples, the electrical behaviour of the various CFGPs tested was measured with a powder ampmeter/I-V instrument. The CFGP was compressed at 3000 psig in a press to minimize dead air volumes between molecules, affecting the measurement of conductivity. The set-up used is also described in Vanga Bouanga et al. (Electrical resistivity characterization of silicon carbide by various methods, IEEE Intern. Symposium on Electr. Insul. (ISEI), pp 43-47, June 2012), incorporated herein by reference in its entirety. Briefly, during powder compression, a micrometer measures the gap. After reaching the desired pressure, a voltage ramp is applied and the current is monitored. The signals of gap voltage and current are acquired in real time with an acquisition system.

### EXAMPLE 1

### Effect of ratios Aluminium (metal) to boron compound

To illustrate the ratio effect of Al to BN ratios, three (3) CFGP mixes were prepared, all being subjected to high energy ball milling for 12 hours in a SPEC 8000M™ mixer/mill, followed by firing at 1040° C. for 2 hours. At the end of the firing step, the mixes were left at room temperature to cool down. As previously explained, without external acceleration or reduction of the cooling down, the mix was cooling down at a rate of about 10° C. per minutes until the mixes reach a temperature around 400° C., after which the cooling down was still left unattended, but slower as one may expect. In one of the batches prepared, a general power failure on the premises reduced the firing step time. In fact, the power failure cause an arrest of the firing step after about 1 hour. It was however noted that the CFGP produced had still the same field grading properties. The results on that batch (not shown) proved that a shorter firing step was still acceptable.

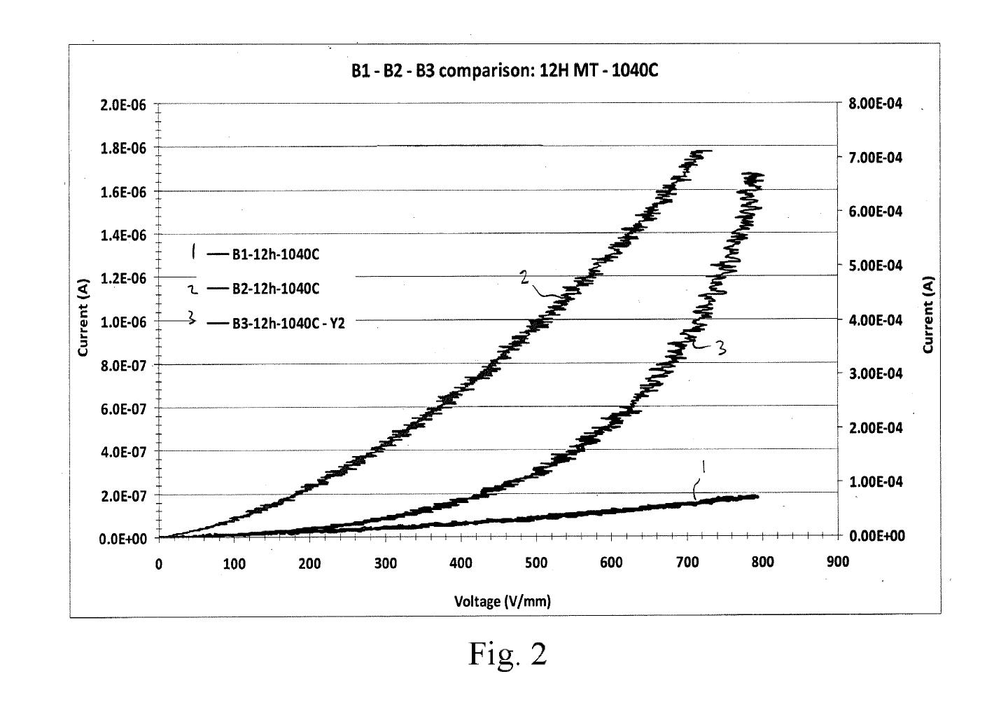

In CFGP mix identified as B1, a stochiometric ratio of 1 Al for 2 BN (1.76 g of Al for 3.24 g of BN) was used. In the B2 mix, a stochiometric ratio of 1 Al for 1 BN (1.605 g of Al for 2.395 g of BN) was used. Finally, for the B3 mix, a stochiometric ratio of 1.4 Al for 1 BN (3.015 g of Al for 1.985 g of BN) was used. It was noted in this example that the more metal, i.e. aluminum in this example, is used, the more borides are produced. As can be seen in FIG. 2, all 3 CFGPs produced with the method as described herein have semi-conductor properties, i.e. powders having good field grading properties. Moreover, also as illustrated in FIG. 2, the more aluminum is used in the milling process, the more conductive is the powder so produced. AlB₂ and Al_{1.67}B₂₂ have both been produced in varying amounts depending on the ratios of starting material used.

### EXAMPLE 2

### Effect of milling time

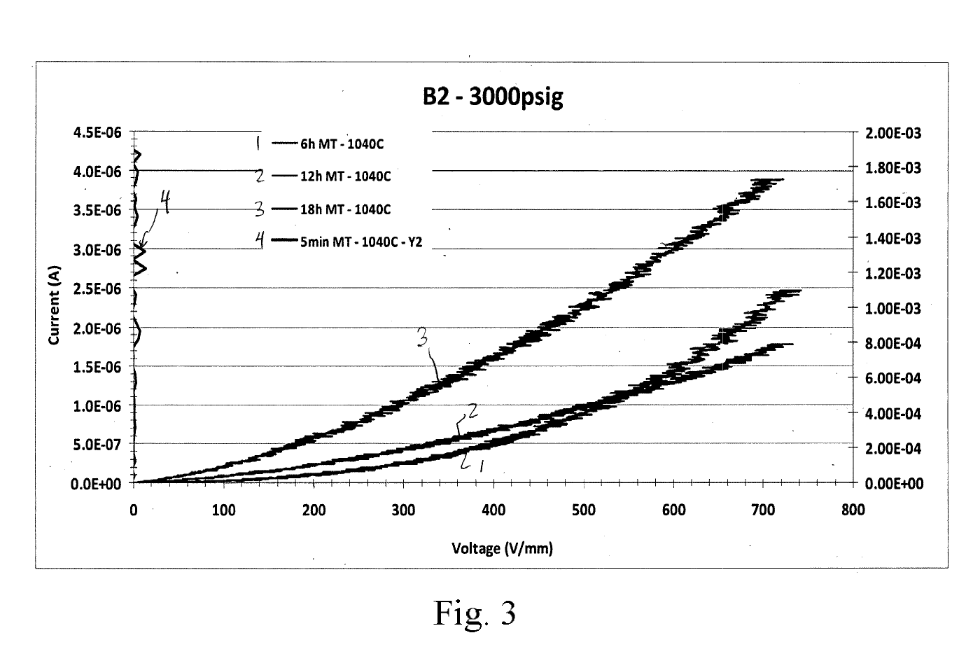

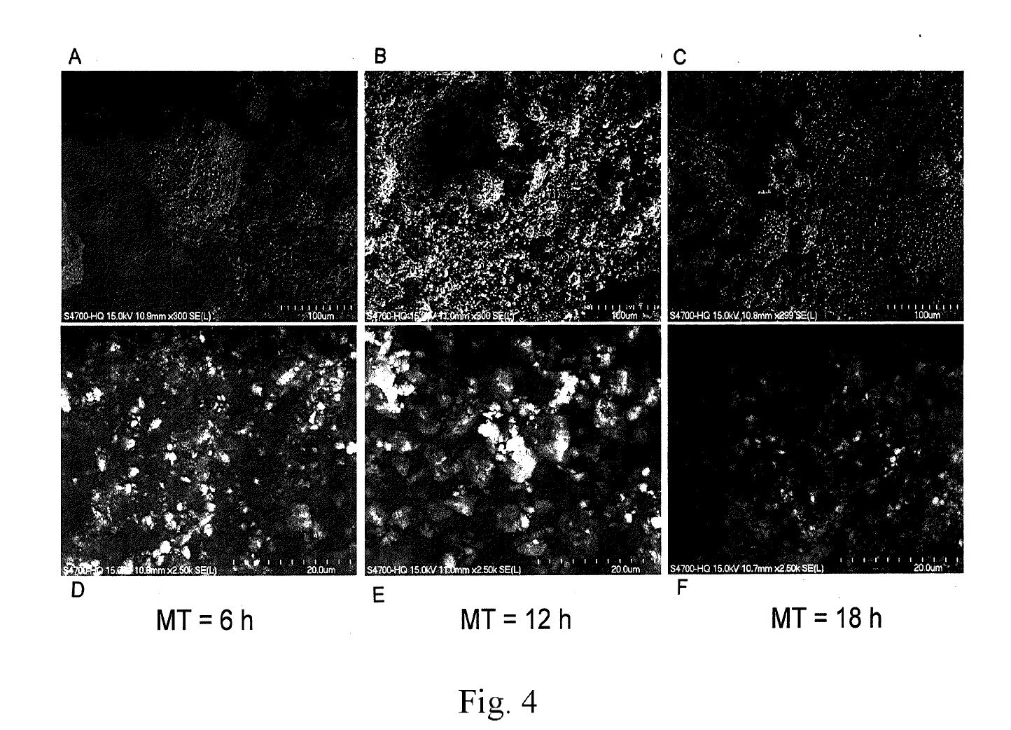

To illustrate the effect of milling time, in the preparation of compound B2 as reported in Example 1, the conductivity of the compound was tested after 5 minutes, 6, 12 or 18 hours of milling, and further fired at 1040° C. X-ray diffraction analysis reported that the longer the milling time, the more borides are produced. Moreover, as can be seen from FIG. 3, the milling time changes the non-linearity of the conductivity curves obtained, due to changes in the powder microstructure, further confirmed by micrographs obtained from scanning electron microscope (FIGS. 4A to 4F). FIGS. 4A-4C illustrates electron scanning micrographs at a first resolution, for milling times 6, 12 and 18 hours, respectively, whereas FIGS. 4D-4F illustrates electron scanning micrographs at a higher resolution, for milling times 6, 12 and 18 hours, respectively. This annealing temperature was selected based on the phase diagram of FIG. 1. The electrical behaviour of the B2 CFGP was measured with the powder ampmeter/I-V instrument as previously described. It is observed that the I-V slope shows a typical dependence with milling time. The milling time changes the powder microstructure, as exhibited by the non-linearity in the I-V curve as a function of the milling time. After 5 minutes of milling, the powder is observed to be still very conductive. In these conditions, the applied voltage cannot be increased since the voltage source falls in current limit mode. After six hours of milling time, a non-linear behaviour can be observed. The change in the I-V curve as a function of milling time is attributed to boride formation, as well as to particle size variation.

From FIGS. 3 and 4A to 4F, it can be appreciated that the slope depends on the powder granulometry, although all of the CFGPs prepared had good field grading properties. The finer the powder (smaller particle sizes), the lower the I/V slope. A greater slope variation is observed after a 6-hour milling time. In fact, it was noted that Al_{1.67}B₂₂ is preferentially made over AlB₂ at higher temperature. However if the milling time is increased, not only is the granulometry of the powder finer, but more Al_{1.67}B₂₂ will be produced as more energy is transmitted to the mix. The increase in the milling time thus allows to lower the temperature of formation of borides, if desired.

### EXAMPLE 3

### Effect of Firing (Annealing) Temperature

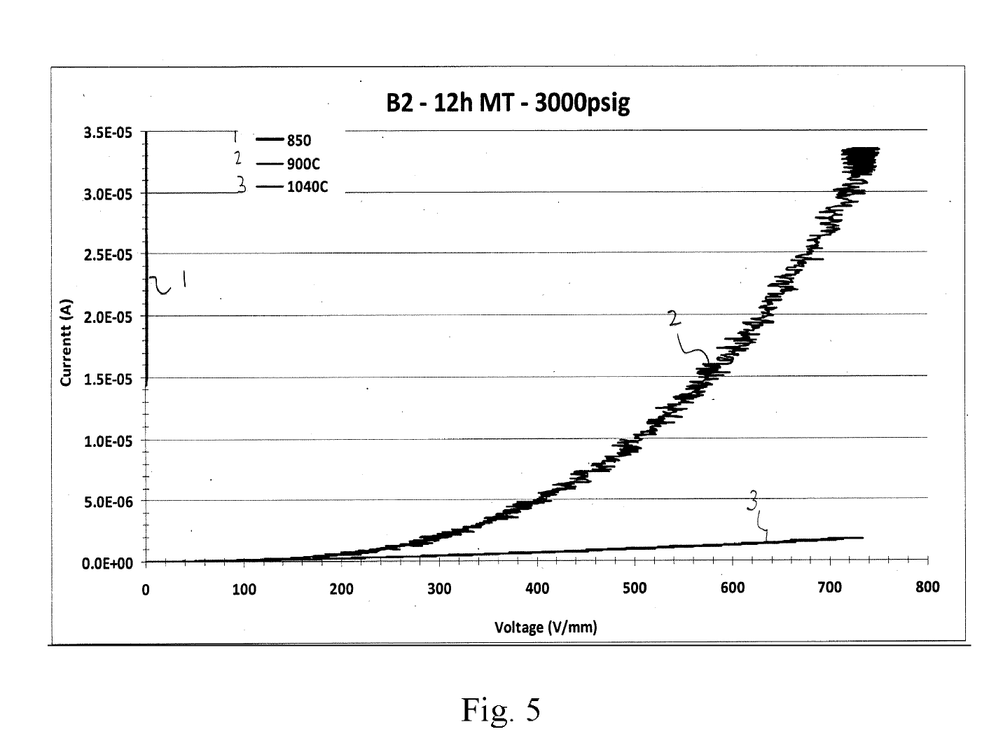

The effect of annealing on the I-V behaviour is illustrated in FIG. 5. The B2 CFGP mix was milled for 12 hours, and annealing was carried out at different firing temperatures. From the drastic change in measured current, the threshold reaction temperature can be set at a value over 850° C. At 850° C., the high conductivity of the powder does not allow an increase in the applied voltage, and the source voltage falls in current limit mode. At 900° C., the I-V slope shows boride formation, also confirmed by the X-ray diffraction results. The change observed in this short interval of temperature is indicative that borides are formed, and this reaction consumes the boron and aluminum content, leading to lower conductivity. This also demonstrates that Eq. (2) may be incomplete. A non-linear behaviour was observed above 850° C., and better between 900° C. and 1040° C., and may be explained by the fact that less boride is produced at a fixed milling time when the annealing temperature increases.

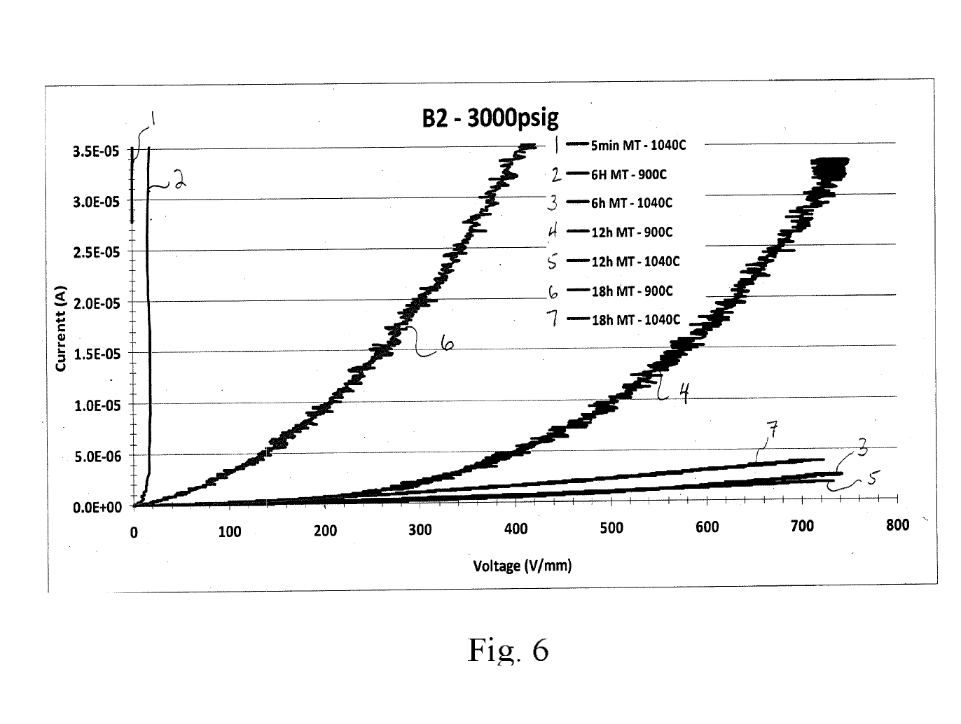

FIG. 6 illustrates the compounded milling time and firing effect on the I-V slopes for the B2 CFGP mix. It now becomes apparent from FIG. 6 that one can customized the CFGP to get the I-V slope desired to obtain the field grading material desired for any specific use, adjusting the temperature, the milling time and the metal to boron ratio to arrive at the desired curve, using as a starting point for initial adjustment the various curves presented herein.

### EXAMPLE 4

### SiC and CFGP Comparison

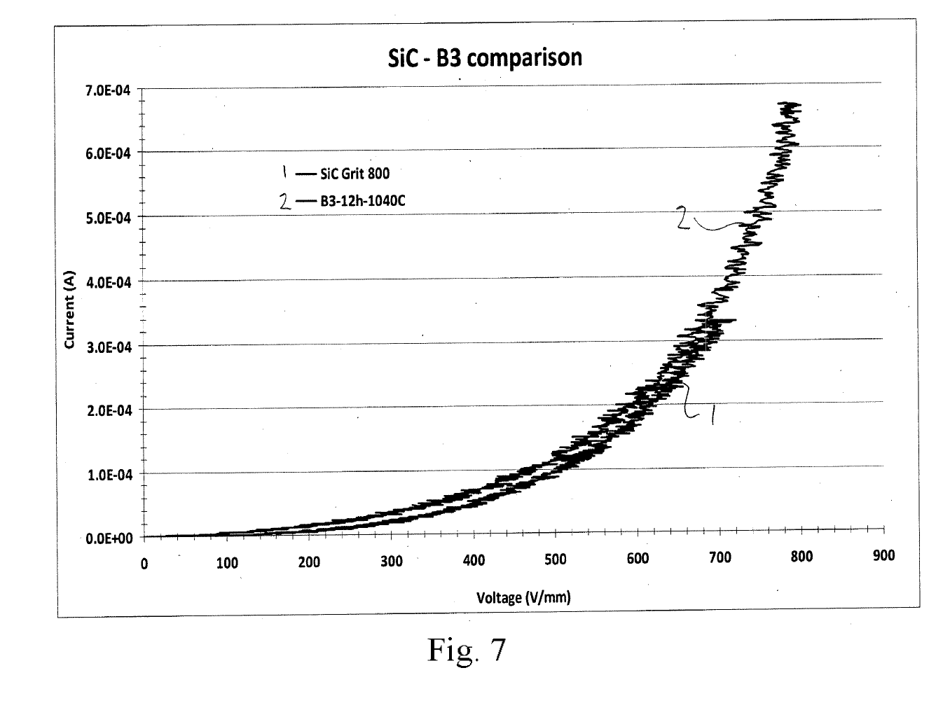

FIG. 7 presents a comparison between a commercial SiC powder and B3 CFGP powder. As measured, the average particle size for the SiC used herein is approximately 12 μm. As for the B3 CFPG mix used, SEM images showed that B3 CFGP mix is made of microparticles composed of nanoparticles smaller than 300 nm. The results in I/V terms are found to be quite comparable. It also implies that the B3 CFGP was successfully tailored to the behaviour of commonly used SiC.

As mentioned earlier, the I-V slope for a CFGP can be adjusted by playing with the milling, firing and ratio parameters, allowing great flexibility in adopting field grading powder properties.

### EXAMPLE 5

### X-Ray Diffraction Analysis

According to the relevant phase diagram (FIG. 1) of borides, at a low annealing temperature, mostly AlB₂ is formed, and at a high annealing temperature, Al_{1.67}B₂₂ is formed. The reaction scheme was tested at different temperature and can be described as follows (unbalanced):

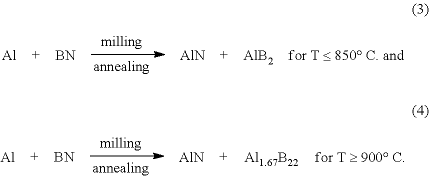

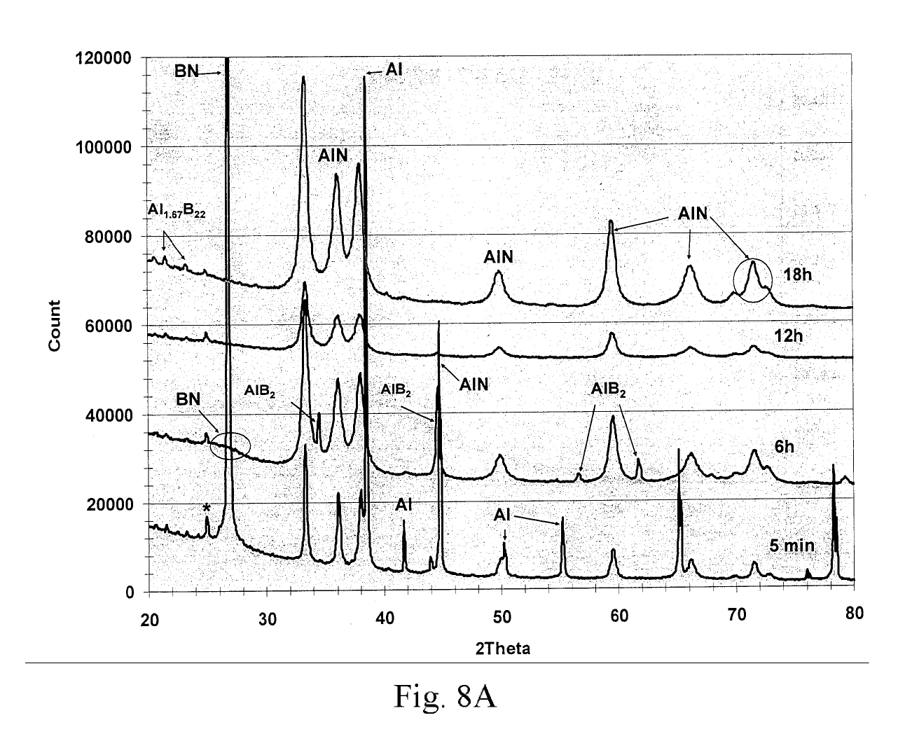

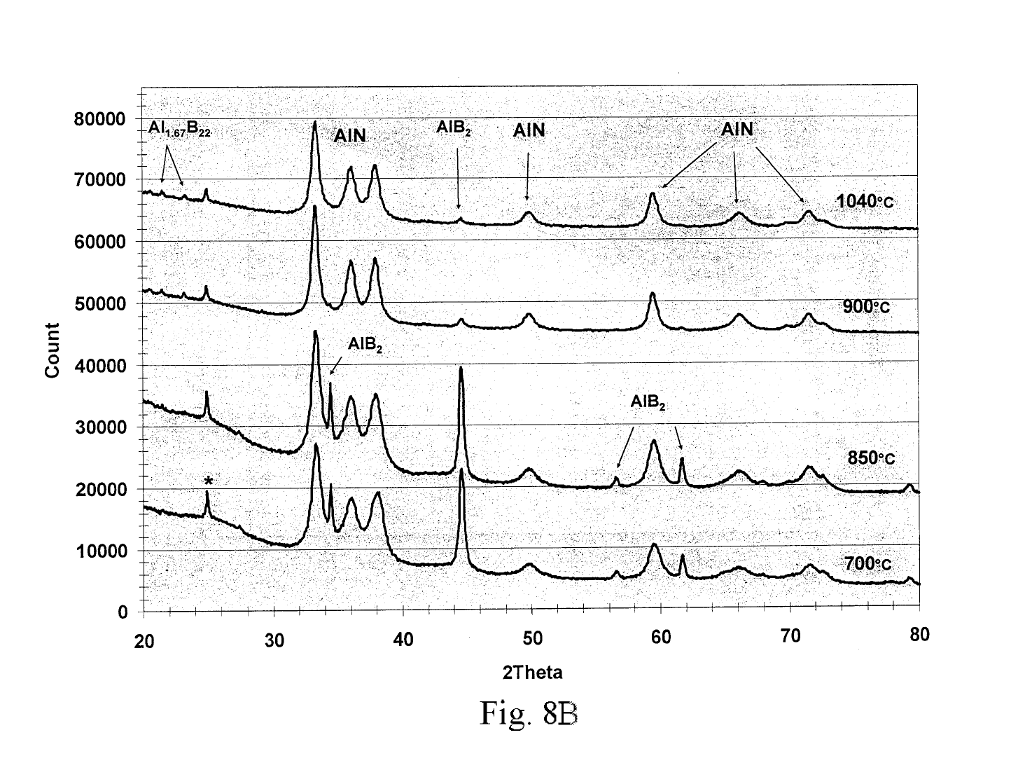

These were further documented with X-ray diffraction (XRD) analysis used to determine the crystal structure of different CFGP, with a Bragg-Brentano geometry used for the analysis. FIGS. 8A and 8B show XRD spectra of a CFGP annealed at 1040° C. for various milling times (8A) and milled for 12 hours at several annealing temperatures (8B). In FIG. 8A, it can be seen that just after 5 minutes of milling time, a significant amount of unreacted aluminum remains in the powder mixture. This explains the conductive nature of the powder at this stage. It also proves that without the insertion of BN into the metal matrix during ball milling, borides cannot be formed. When the milling time increases, AIN and AlB₂ are formed. A small amount of unreacted BN persists after up to 6 hours of milling time. However, after 12 hours of milling time, the total of BN seems to have reacted as it is not detectable anymore, resulting in a gradual decomposition of BN into B and N atoms. These observations provide an explanation for the observed lower slope at 6 hours of milling time (FIG. 3) due to the unreacted BN. The greater slope variation after 6 hours of milling time is due to the formation of more borides. After 12 hours of milling time, AlB₂ tends to disappear—the peak intensity decreases. It is clear that between 6 and 18 hours of milling time, the number of peaks shown in the spectrum decreases, which indicates that the structure becomes disordered and fine. It can also be observed that the width of the peaks increases with the milling time (FIG. 8A), which is explained by the decrease in the particle size and by the defects and stresses induced in the material during milling. A decrease in the CFGP intensity peak is observed when the particle size decreases. In FIGS. 8A and 8B, the * denotes a peak caused by the powder holder.

It should however be noted that peak AlB₂ is replaced by peak Al_{1.67}B₂₂, which is evident after 18 hours of milling time. Milling time plays an important role imparting energy to the original mix, lowering the firing temperature to produce aluminum borides. Obviously, more boride is produced with a longer milling time. However, it is possible that several borides were formed, but are not detectable by XRD. From the above considerations, the equation (5) can be rewritten as follows (unbalanced):

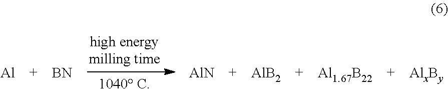

However, the results relative to the powder milled for 12 hours and fired at various temperatures (FIG. 8B) showed, separately from the annealing temperature, that borides are finally formed after a long milling time. The annealing temperature though, plays a role in boride formation. At higher annealing temperatures, a small amount of low borides is formed, and higher-weight boride formation (AlB₂ vs. Al_{1.67}B₂₂) takes place and consumes the free boron content.

The XRD results also confirm that the milling time and annealing each play a role for a complete reaction, varying the field grading properties of the CFGPs formed.

### EXAMPLE 6

### Alternate Source of Boron

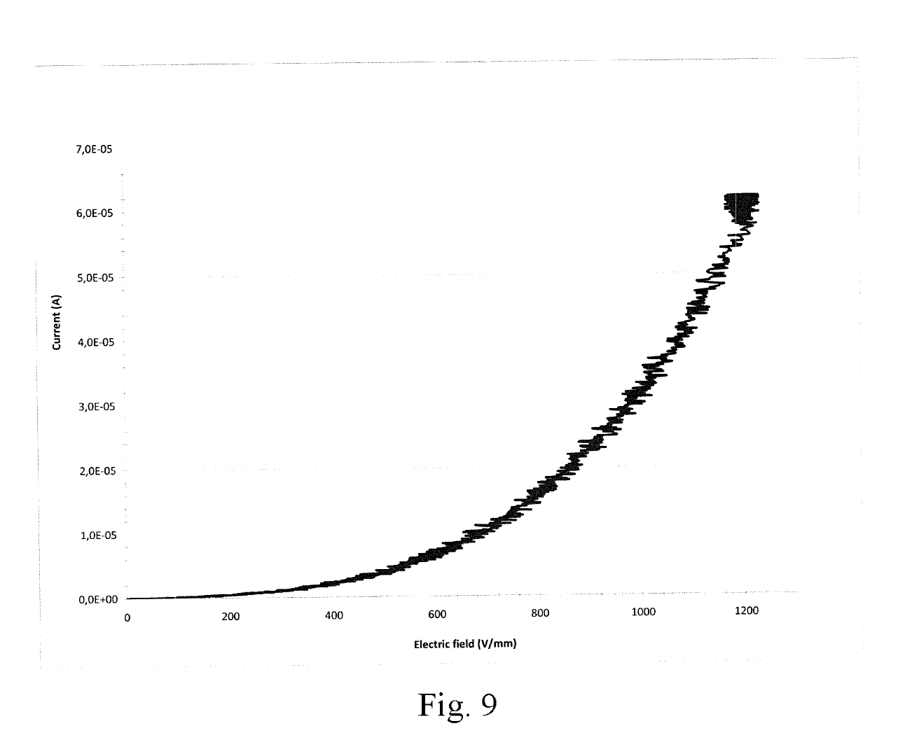

In the example above, all of the above CFGPs were prepared using aluminum as the metal, and boron nitride as the boron compound, milled in a SPEX 8000M miller. In this example, a new CFGP powder is prepared, using Aluminium and boric acid as starting material. 1.810 g of Al and 3.190 g of boric acid (>98% pure) were mixed together in the SPEX 8000M miller, milled for 12 hours and fired at 900° C. As can be seen from FIG. 9, boric acid is a suitable substitute to boron nitride in the formation of a CFGP. FIG. 9 illustrates the I-V curve obtained for this CFGP, showing this new CFGP has properties similar to those previously prepared.

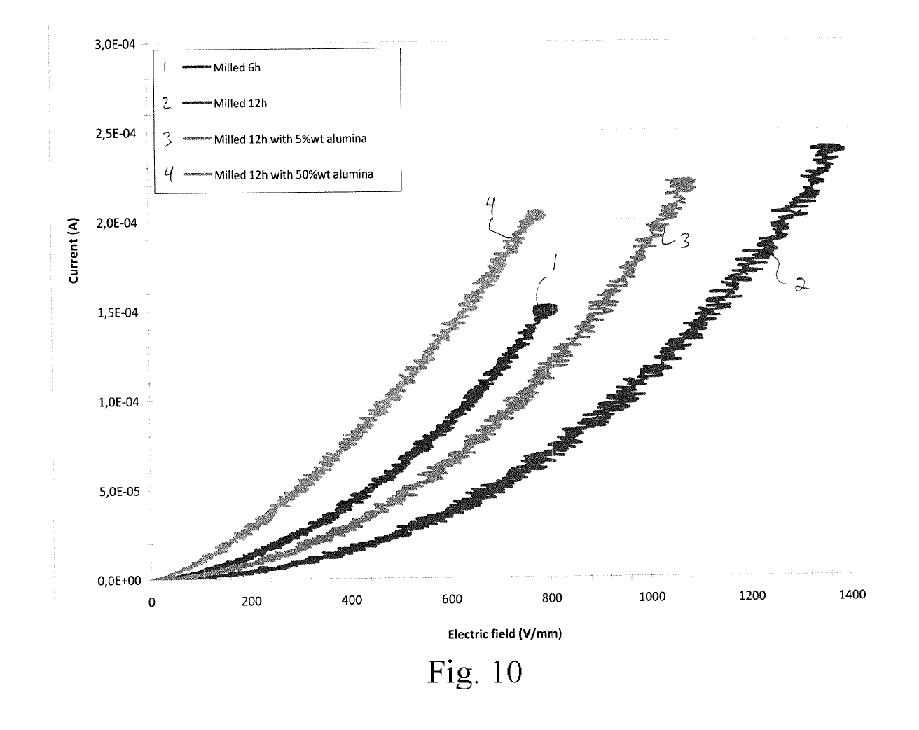

Boron oxide was also tested as a substitute source of boron. In these experiments, boron oxide and aluminum were milled together for 6 or 12 hours, in the presence or absence of alumina (5% or 50% wt/wt). The powder was fired at 900° C. The I-V curves obtained for these CFGPs as illustrated in FIG. 10 also shows similar properties suitable for use in a field grading material. The addition in this case of alumina allows not only to control the exothermic reaction, but also to further tailoring the I-V slope and thus the desired properties of the CFGP for field grading, forming in the reaction B₂O₃ and Al₂O₃.

### EXAMPLE 7

### Effect of Different Ball Milling

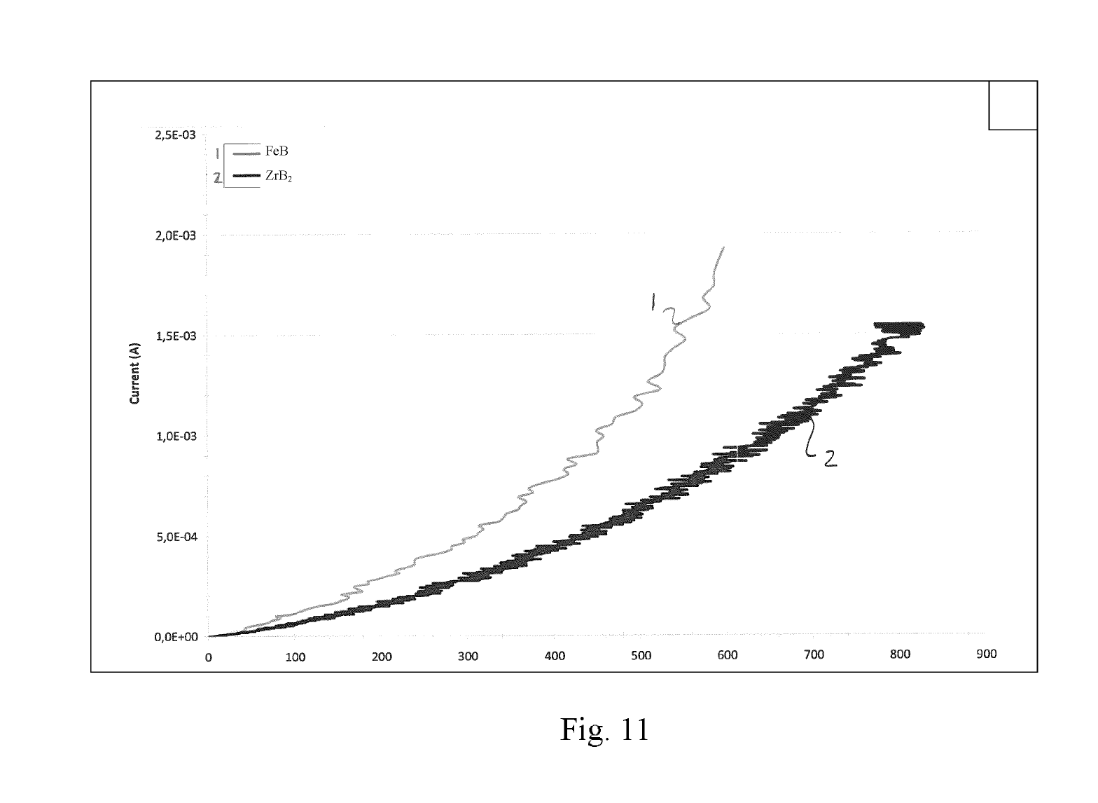

All of the CFGP powders prepared above, all were milled in the SPEX 8000M miller. Upon contemplating alternate method of production, a planetary ball miller (Retsch PM400MA™) was used with 15 grinding balls of 20 mm in diameter of either hardened iron or zirconium oxide in a 250 ml crucible (of the same material as the grinding balls). Planetary ball miller causes less impact, but more shear in use. Thus aluminum and boron nitride were milled for 12 hours at 400 rpm in the planetary miller using hardened iron or zirconium oxide grinding balls. The resulting powder was then fired 900° C. at for 2 hours. It was determined following X-ray diffraction analysis that the resulting CFGP was containing other borides produced by the abrasion of the iron or zirconium oxide balls. The resulting CFGP in one case with the iron balls was containing iron boride (FeB) as the only form of boride. The aluminum powder was converted into AlN. Similarly, the resulting CFGP in the other case with the zirconium oxide balls was containing zirconium diboride (ZrB₂) as also the most abundant form of boride. The CFGP also contained unreacted BN, Zirconium Yttrium oxide (from the zirconium balls), Zirconium oxide nitride and AlN. As can be appreciated in FIG. 11, the I-V curves for both CFGPs are still showing similar properties adapted for field grading. Hence, it has become apparent after this experiment that not only aluminum borides would be good field grading powder, but in general metal boride as well. It has been shown in this experiment that CFGP containing ZrB₂ and FeB as the source of metal borides are as well good field grading powders. Zr, Fe and Al being in distinct classes of metals, it is expected that the other metals in the classes of Zr, Fe and Al, such as metals from groups 4, 8 and 13, will also be suitable for preparing CFGP for field grading. Moreover, it can also be appreciated that since the 3 metals tested are from 3 different classes but are all 3 metals, a person skilled in the art would also expect that any metal would be acceptable for preparing CFGP as described herein, with good field grading properties.

Accordingly, it is now clear that various metals can be used. The CFGP powders should not be limited to aluminum borides, but can be made with metal boride, following the method as explained herein, with the milling and firing steps.

While the invention has been described in connection with specific embodiments thereof, it is understood that it is capable of further modifications and that this application is intended to cover any variation, use, or adaptation of the invention following, in general, the principles of the invention and including such departures from the present disclosure that come within known, or customary practice within the art to which the invention pertains and as may be applied to the essential features hereinbefore set forth. For example, the milling and firing steps could be conducted simultaneously, with the same successful result. However, for practical and commercial considerations, conducting both steps together may be less advantageous or may require a more complex set up.

1. A method for producing a field grading powder with semi-conductor properties, said method comprising the steps of:
a) ball milling under high energy a metal powder and a boron compound to obtain an homogenous powder;
b) annealing said homogenous powder at a temperature and a time sufficient for creating a metal boride powder; and
c) cooling down the metal boride powder from step b) for obtaining a field grading powder having semi-conductor properties.

2. The method of claim 1, wherein the metal boride is AlₓB_{y}, FeB, or ZrB₂, wherein x and y may vary resulting in different aluminum borides depending on the time of milling and firing.

3. The method of claim 1, wherein the metal is aluminum, iron or zirconium.

4. The method of claim 1, wherein the metal is aluminum.

5. The method claims 1, wherein the boron compound is boron nitride, boric acid, borate or boron oxide.

6. The method of claim 1, wherein the temperature of annealing is of at least 900° C.

7. The method of claim 1, wherein the temperature of annealing is of at least 1040° C.

8. The method of claim 1, wherein the time of annealing is of at least 1 hour.

9. The method of claim 1, wherein the time of firing is of at least 2 hours.

10. A field grading powder as produced by the method of claim 1.

11. The field grading powder of claim 10, said field grading powder comprising aluminum boride.

12. The field grading powder of claim 10, said field grading powder comprising FeB.

13. The field grading powder of claim 10, said field grading powder comprising ZrB₂.

14. Use of a field grading powder as defined in claim 10, for field grading.

15. The use of claim 14, in cable terminations and end windings.

16. Use of a field grading powder for field grading in termination cables and end windings, said field grading powder being produced by the method of claim 1.

17. A method for producing a field grading material, said method comprising incorporating in said material or at its surface a field grading powder as defined in claim 10.
